(19) United States
(12) Patent Application Publication
(10) Pub. No.: US 2004/0128671 A1
(43) Pub. Date: Jul. 1, 2004

(54) Software architecture for control systems

(76) Inventors: Kenneth P. Koller, Moss Beach, CA (US); Rajesh K. Batra, East Palo Alto, CA (US)

Correspondence Address: Todd M. Becker, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/335,747

(22) Filed: Dec. 31, 2002

(51) Int. Cl. G06F 9/00

(52) U.S. Cl. 718/100

(57) ABSTRACT

The present application discloses a software architecture. In one embodiment, the software architecture is an apparatus comprising a processor, a real time thread comprising a real-time module that can be executed by the processor, a non-real-time thread comprising a non-real-time module that can be executed by the processor or a separate processor independently of the real-time thread, and a external communication thread executed by the processor for handling communications between the real-time thread and the non-real-time thread. In another embodiment, the architecture is a process comprising executing a real time thread comprising a real-time module, executing a non-real-time thread comprising a non-real-time module independently of the real-time thread, and executing a external communication thread for handling communications between the real-time thread and the non-real-time thread. Other embodiments are described and claimed.

### TECHNICAL FIELD

The present invention relates generally to control systems and in particular, but not exclusively, to a software architecture for use with control systems.

### BACKGROUND

Many devices have their operations governed by a control system. For proper operation, the control system often must perform a series of real-time (RT) steps, as well as a series of non-real-time (NRT) steps with looser time constraints. Since most control systems rely on software for their operation, this means that the software itself must also be capable of performing and directing both RT and NRT operations. This, often times, is supported by operating systems utilizing threads or tasks. RT and NRT threads, however, have different constraints and characteristics, and it is often difficult to utilize and coordinate threads logically and efficiently to achieve a certain behavior, particularly in a way that efficiently uses processor time and memory space.

One existing approach for utilizing RT and NRT threads in control software has been to simply create as many threads of each type as needed. This design has several disadvantages. Among other things, it makes inefficient use of resources (e.g., processor time and memory space), since RT and NRT threads have “overhead” that the operating system must maintain, and it requires the programmer to create mechanisms for the threads to communicate to avoid contention and starvation of data. Similarly, this approach makes design of the control software difficult because of the haphazard combination of RT and NRT threads. Combining the RT and NRT threads also makes testing and prototyping of the control system difficult because there is no clean separation between the various threads. Thus, for example, an engineer seeking to test some isolated RT behavior of the software would find it difficult to isolate the behavior because of the co-dependency of the threads, and may also run unnecessary multiple portions of the software as well.

Another existing approach is not to use threads at all, but rather to use a monolithic design including a single loop that represents all functions as real-time functions, but uses hardware interrupts to determine which functions are actually carried out in real time and which are not. The monolithic approach results in a more efficient use of computational resources such as the processor, but still suffers from the separability and co-dependency problem mentioned above, making it difficult to de-couple and isolate the behaviors governed by the software.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a diagram of an embodiment of the present software architecture.

FIG. 2 is a diagram illustrating an alternative embodiment of the present software architecture.

FIG. 3 is a diagram illustrating another alternative embodiment of the present software architecture.

### DETAILED DESCRIPTION OF THE ILLUSTRATED EMBODIMENTS

Embodiments of software architectures are described herein. In the following description, numerous specific details are described to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in this specification do not necessarily all refer to the same embodiment. Furthermore, the particular features, structures, or characteristics may be combined in any suitable manner in one or more embodiments.

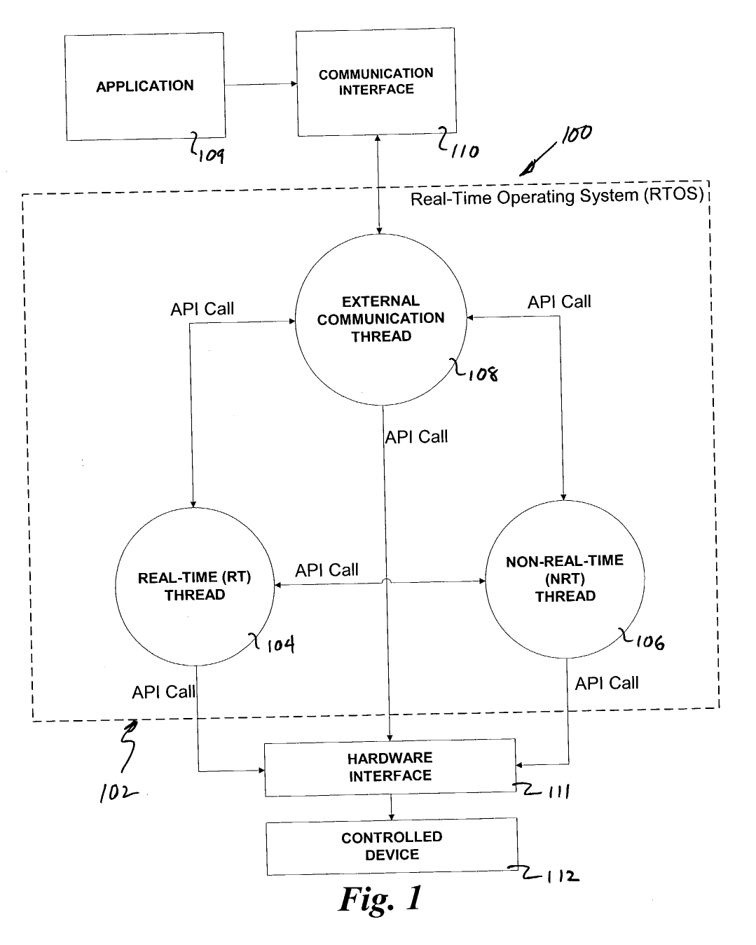

FIG. 1 illustrates an embodiment of the invention comprising software architecture 100. The software architecture 100 runs on a processor, controller, or other physical device having a real-time operating system (RTOS) 102, and comprises a real-time thread 104, a non-real time thread 106, and an external communication thread 108. The real-time thread 104 and non-real-time thread 106 communicate with each other, and with certain devices outside the processor, using the external communication thread 108, although the real-time and non-real-time threads also can communicate directly with each other without using the external communication thread 108 as an intermediary, typically via an application program interface (API). The real-time thread 104 and the non-real-time thread 106 also communicate directly with the controlled device 112 through the hardware interface 111.

Most computer operating systems are non-real-time: when a command or function call is issued, it is queued and later executed whenever the operating system can allocate the resources (e.g., processor time and memory space) needed for its execution; in essence, the operating system executes the command whenever it gets around to it, rather than within a certain well-defined amount of time. In this situation the time between issue of a command and its execution by the operating system cannot be known in advance, and it is therefore a non-real-time function. There are, however, real-time operating systems (RTOS) that perform functions in real time. Any software that performs functions requiring regular and deterministic timing must use an RTOS. Software that performs non-real-time functions can also run on an RTOS, but not vice-versa; real-time software cannot run on a non-real-time operating system.

Generally, the controller (e.g., a processor) running the RTOS and the real-time and non-real-time threads can only execute one thread at a time, meaning that some sort of prioritization scheme is needed to govern the execution of the threads. The prioritization scheme will usually be managed by the RTOS. Because of the much tighter time constraints placed on the real-time thread 104, it always receives the highest priority. The non-real-time has much less stringent time constraints, and therefore has a lower priority. That being the case, the RTOS suspends all non-real-time and external communication functions to allow the real-time thread to run. When the real-time thread is finished, the external communication thread 108 and the non-real-time thread 106 utilize the remaining time, typically in a round-robin fashion, until the real-time thread's next execution.

The real-time thread 104 performs functions having deterministic timing requirements—that is, they must be performed within a small and certain time, or must be performed periodically at very precisely timed intervals. In contrast, non-real-time threads tend to be threads that are not time-critical; the non-real-time thread 106 performs functions that do not have deterministic timing requirements, but rather have indefinite or probabilistic time requirements. The real-time thread 104 and the non-real-time thread 106 also communicate directly with each other, and with the hardware interface 111, using a standard command protocol, such as Application Program Interface (API) calls.

The external communication thread 108 communicates with certain external devices coupled to the controller, such as the application 109 and communication interface 110, using standard communication protocols such as RS-232, Ethernet, SPI, CAN BUS, RS-423, or I²C. Between the external communication thread and the real-time and non-real-time threads, communication takes place using API calls. Thus, the external communication thread 108 in this embodiment can be viewed primarily as a translator to translate between the protocol used for external communication and the commands used for internal communication. In one example, the external communication thread 108 can translate a command received in a RS-232 protocol from the communication interface 110 into an API call that directs the non-real-time thread 106, the real-time thread 104, or both, to perform some function. As the relevant thread performs its function, it makes the appropriate API call to the controlled device 112 through the hardware interface 111, either directly or through the external communication thread 108 which can also send API calls directly to the hardware interface 111.

As shown, the architecture thus segregates the real-time thread and its associated functional modules from the non-real-time thread and its functional modules, meaning that the real-time thread is made independent of the non-real-time thread. The architecture 100 thus provides many advantages compared to prior approaches. Among other things, the clean and well-defined partition between real-time and non-real-time threads, and their independence, allows for efficient management and organization of software. In turn, this leads directly to more efficient use of computational resources, such as processor time and memory space. The separation of real-time and non-real-time threads also shortens the design cycle for control software, because the independence of the threads allows non-real-time threads to be disabled without affecting the real-time threads. Furthermore, a non-real time thread can be redirected to an auxiliary machine. There is no stipulation that a thread must run on a single processor. A non-real time thread can coordinate the controlled device 112, via the hardware interface 111. In this case, the external communication thread is assumed to have non-real time response, and therefore allows only non-real time threads to be redirected. However, one can see that if the bandwidth is sufficiently increased (greater than the real-time needs), real-time behavior can be emulated as well. The ability to disable non-real-time threads allows designers to more easily prototype new applications on auxiliary machines using higher-level programming languages, while the independence of the threads allows software designers to concurrently develop real-time and non-real-time applications. Finally, separating the external communication thread from the real-time and non-real-time threads allows the external communication thread to be easily and efficiently swapped if there is a change in communication protocols.

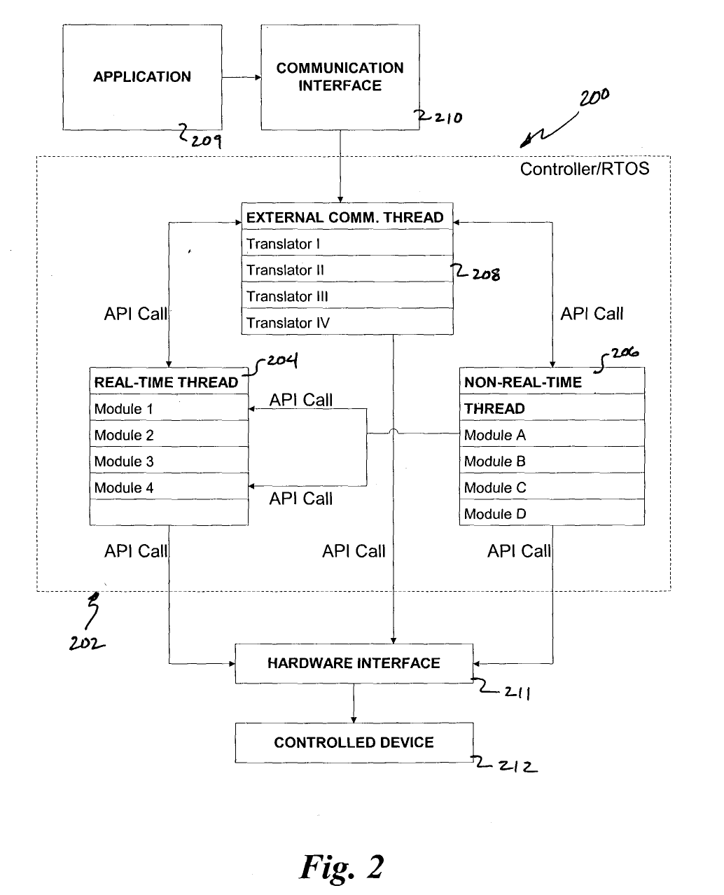

FIG. 2 illustrates an alternative embodiment of the invention comprising software architecture 200. In this embodiment, the entire software architecture 200 runs on a single controller/processor using a single environment or operating system, in this case a real-time operating system (RTOS) 202. As in the previous embodiment 100, this embodiment comprises a real-time thread 204, a non-real time thread 206, and an external communication thread 208 coupled to both the real-time and non-real-time threads. The external communication thread 208 is also linked to, and in communication with, some devices external to the controller, such as the communication interface 210, through which the application 209 communicates with the controller/processor. The external communication interface 208 also communicates with the controlled device 212 through the hardware interface 211

As before, the real-time thread 204 performs functions that are deemed to be real-time, and the non-real-time thread 206 performs functions that are deemed to be non-real-time. A software designer will usually determine whether a function is real-time or non-real-time and place that functionality in the appropriate thread. In cases where a function does not fit cleanly into one thread, the function can be split into sub-functions executed by both threads. In the software architecture 200, the real-time thread 204 comprises one or more real-time functional modules, labeled 1-4 in the drawing, each of which works in conjunction with the RTOS to perform a specific real-time function. Similarly, the non-real-time thread 206 will usually comprise one or more non-real-time functional modules, labeled A-D in the drawing, which perform specific non-real-time functions, either alone or by invoking and coordinating one or more modules 1-4 of the real-time thread. Modules within the non-real-time thread can thus call one or more modules of the real-time thread using some sort of interface. The real-time thread 204 and the non-real-time thread 206 communicate directly with each other, and with the external communication thread 208 and the hardware interface 211, using a standard command protocol, such as Application Program Interface (API) calls.

As in the software architecture 100, the external communication thread 208 handles communications between external devices, such as the communication interface 210 and the hardware interface 211, and the real-time thread 204, and the non-real-time thread 206. The communication interface 210 communicates with the external communication thread 208 using any kind of communication protocol; examples include RS-232, Ethernet, SPI, CAN BUS, RS-423, or I²C. The external communication thread 208 then communicates with the non-real-time thread 206 and the real-time thread 204 using API calls. The external communication thread, then, translates between the external communication protocol it receives from the communication interface 210 and the internal API calls used among the three threads. In the software architecture 200, the external communication thread 208 can be modularized so that it simultaneously supports various communication protocols. As shown, the external communication thread comprises four translation modules labeled I through IV, each of which can translate a different communication protocol into the API calls needed for internal communication among the threads. All communication among the external communication thread, the non-real-time thread and the real-time thread is preferably done using API calls.

The application 209 and communication interface 210 can, in one embodiment, reside on a device such as a computer. The application 209 issues instructions to be carried out by the controlled device 212 using the software architecture 200. In other embodiments, the communication interface could be another device coupled to the system that can send commands to the system. The controlled device 212 may be any kind of device whose operation needs or is enhanced by close monitoring and control. One example of a controlled device 212 is an external cavity laser, although the software architecture 200 is not limited to use with lasers. Operation of the software architecture 200 can be explained using an external cavity laser as an example, although as pointed out above the architecture 200 is not limited to use with lasers. The software architecture 200 can be used, for example, to control the tuning the laser. The tuning of an external cavity laser is usually carried out indirectly by, for example, varying the temperatures of certain components, such as the laser cavity itself or the temperature of one or more filters through which the laser light passes after leaving the cavity. In such a situation, tuning—that is, changing the frequency of the laser output is generally considered a non-real-time function, since it can occur over a long and substantially indeterminate time. Maintaining the required frequency once it is reached, however, is considered a real-time function, since the component temperatures must be tightly monitored and adjustments quickly made to control the laser frequency. If the software architecture 200 is applied to the laser tuning application, then if tuning is required, non-real-time module A can be instructed by the application 209 to change the frequency. The application 209 sends the appropriate commands through the communication interface 210 to the external communication thread 208, which selects from among modules I to IV to translate the protocol received from interface 210 into an API call. The external communication thread 208 then sends the appropriate API call to module A in the non-real-time thread 206. When commanded to change the laser frequency, the non-real-time module A in turn transmits API calls to one or more modules in the real-time thread that will perform the functions needed to change the temperatures and control them as they happen. When they reach the real-time thread 204, the commands from module A can be executed immediately by the real-time thread or can be buffered to await the next possible execution. As the real-time and non-real-time threads perform their functions, they send appropriate commands to the hardware interface 211 and the controlled device 212, either directly or through the external communication thread. In the illustrated example, non-real-time module A, when instructed by the communication interface 210 to change the frequency of a laser, transmits API calls to real-time modules 2 and 4. Real-time module 2 may, for example, control and maintain the temperature of the laser cavity at the temperature transmitted to it by module A, while real-time module 4 can control and maintain the temperature of a filter at the temperature transmitted to it by module A. As they perform their functions, module A and modules 1 and 4 send commands to the hardware interface 211, which then controls the temperatures of the laser cavity and filters.

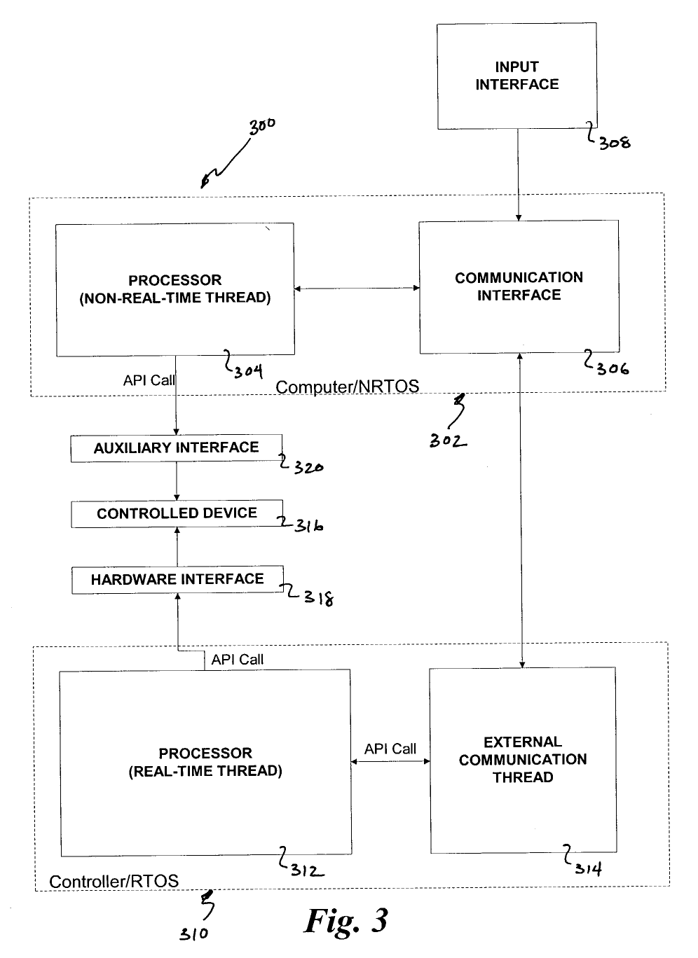

FIG. 3 illustrates an alternative embodiment of the software architecture 300. The software architecture 300 is implemented across more than one platform, instead of running on a single processor/controller like the software architecture 200 shown in FIG. 2. As shown, the software architecture 300 comprises a computer 302, a controller/processor 310 having an RTOS, a communication interface 308, and a controlled device 316 coupled to the computer 302 and the controller 310.

The computer 302 can be any type of computer, such as a personal computer (PC), a mainframe, or an embedded system. The computer 302 includes a processor 304 having an operating system that can be either a real-time operating system (RTOS) or a non-real-time operating system (NRTOS). The processor 304 executes a non-real-time thread. The processor 304 is coupled to, and communicates with, a communication interface 306 and an auxiliary interface 320. The communication interface 306 is also coupled to and communicates with an input interface 308 and an external communication thread 314 executed by the controller/processor 310, while the auxiliary interface 320 is also coupled to the controlled device 316. Thus, the processor 304, and hence the non-real-time thread it executes, can communicate directly with the controlled device 316 using API calls via the auxiliary interface 320, and can communicate with the real-time thread 312 via the communication interface 306 and the external communication thread 314.

The controller/processor 310 executes a real-time thread 312 and a external communication thread 314. As before, the real-time thread works in conjunction with the RTOS to perform one or more specific real-time functions. The real-time thread 312 communicates directly with an external communication thread 314, and also communicates with the controlled device 316 through a hardware interface 318. Communication between the real-time thread 312, the external communication thread 314, and the hardware interface 318 takes place through API calls. In this embodiment, however, the real-time thread 312 cannot communicate directly with the non-real-time thread 304 via API calls. Instead, the real-time thread communicates with the non-real-time thread through the external communication thread 314 and the communication interface 306. Communication between the external communication thread 314 and the communication interface 306 takes place using some communication protocol such as RS-232, Ethernet, SPI, CAN BUS, RS-423, or I²C.

Operation of the software architecture 300 can again be explained using the tuning of an external cavity laser as an example, although as before the architecture 300 is not limited to use with lasers. If the software architecture 300 is applied to the laser tuning application, then if tuning is required, non-real-time thread 304 can be instructed 308 and the communication interface 306 to change the frequency. When commanded to change the laser frequency, the non-real-time thread 304 in turn transmits the command to the communication interface 306, which forwards it to the external communication thread 314 in the controller/processor 310 using some communication protocol. The external communication thread 314 translates the received command into an API call and forwards it to the real-time thread 312, which then performs the real-time functions needed to change and control the temperatures and sends the appropriate commands (API calls) to the controlled device 316 through the hardware interface 318. In some cases, both the real-time thread 312 and the processor 304 running the non-real-time thread can operate the controlled device 316. For example, the controlled device can be an external tunable laser that has several lines for getting and setting temperature values. These values may require both real-time and non-real-time monitoring. In such a case, the non-real-time thread sends commands directly to the controlled device 316 through the auxiliary interface 320, while the real-time thread continues to send commands to the controlled device 316 through the hardware interface 318.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description.

The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

1. An apparatus comprising:
a processor;
a real time thread comprising a real-time module that can be executed by the processor;
a non-real-time thread comprising a non-real-time module that can be executed by the processor independently of the real-time thread; and
an external communication thread executed by the processor for handling communications between the real-time thread and the non-real-time thread.

2. The apparatus of claim 1, further comprising a real-time operating system (RTOS) executed by the processor.

3. The apparatus of claim 2 wherein the RTOS prioritizes the real-time thread, the non-real-time thread and the external communication thread.

4. The apparatus of claim 1 wherein communication between the external communication thread, the real-time thread and the non-real-time thread takes place using a standard communication interface.

5. The apparatus of claim 4 wherein the standard communication interface is an application program interface (API) call.

6. The apparatus of claim 1, further comprising a communication interface coupled to the external communication thread, wherein the communication interface accepts commands from an application to be sent to the external communication thread.

7. The apparatus of claim 6 wherein communication between the external communication thread and the communication interface uses a standard communication protocol.

8. The apparatus of claim 7 wherein the communication protocol is RS-232, Ethernet, SPI, CAN BUS, RS-423, or I²C.

9. The apparatus of claim 1 wherein the non-real-time thread can transmit a command directly to the real-time thread.

10. The apparatus of claim 1 wherein the processor comprises a first processor and a second processor, and wherein the real-time thread runs on the first processor and the non-real-time thread runs on the second processor.

11. The apparatus of claim 1, further comprising a controlled device coupled to the external communication thread, the real-time thread and the non-real-time thread, wherein the external communication thread, the real-time thread and the non-real-time thread transmit commands to the controlled device.

12. A computer software architecture comprising:
a real time thread comprising a real-time module;
a non-real-time thread comprising a non-real-time module, the non-real-time thread being independent from the real-time thread; and
a external communication thread for handling communications between the real-time thread and the non-real-time thread.

13. The architecture of claim 12, further comprising a real-time operating system (RTOS).

14. The architecture of claim 13 wherein the RTOS prioritizes the real-time thread, the non-real-time thread and the external communication thread.

15. The architecture of claim 12 wherein communication between the external communication thread, the real-time thread and the non-real-time thread takes place using a standard communication interface.

16. The architecture of claim 15 wherein the standard communication interface is an application program interface (API) call.

17. The architecture of claim 12 wherein the non-real-time thread can transmit a command directly to the real-time thread.

18. The architecture of claim 12, further comprising a communication interface coupled to the external communication thread, wherein the communication interface transmits commands to the external communication thread.

19. The architecture of claim 18 wherein communication between the external communication thread and the communication interface uses a standard communication protocol.

20. The architecture of claim 19 wherein the communication protocol is RS-232, Ethernet, SPI, CAN BUS, RS-423, or I²C.

21. The architecture of claim 12, further comprising a controlled device coupled to the external communication thread, the real-time thread and the non-real-time thread, wherein the external communication thread, the real-time thread and the non-real-time thread transmit commands to the controlled device.

22. A control system comprising:
a controller comprising a processor having a real-time operating system (RTOS);
a real-time driver operatively coupled to the RTOS and comprising a real-time thread that can be executed by the controller;
a non-real-time driver operatively coupled to the RTOS and comprising a non-real-time thread that can be executed by the controller;
a external communication thread for handling communications between and among the real-time thread, the non-real-time thread, and the RTOS; and
a controlled device operatively connected to and controlled by the controller.

23. The apparatus of claim 22 wherein the RTOS prioritizes the real-time thread, the non-real-time thread and the external communication thread.

24. The control system of claim 22 wherein the device communicates with the real-time driver and the non-real-time driver through the external communication thread.

25. The control system of claim 22, further comprising a communication interface operatively coupled to the controller, wherein the communication interface can transmit a command to the external communication thread.

26. The apparatus of claim 25 wherein communication between the external communication thread and the communication interface uses a standard communication protocol.

27. The apparatus of claim 22 wherein communication between the external communication thread, the real-time thread and the non-real-time thread takes place using a standard communication interface.

28. The apparatus of claim 27 wherein the standard communication interface is an application program interface (API) call.

29. The apparatus of claim 22 wherein the non-real-time thread can transmit a command directly to the real-time thread.

30. The apparatus of claim 22 wherein the processor comprises a first processor and a second processor, and wherein the real-time thread runs on the first processor and the non-real-time thread runs on the second processor.

31. An article of manufacture, comprising a machine-readable medium having instructions stored thereon to:
execute a real time thread comprising a real-time module;
execute a non-real-time thread comprising a non-real-time module; and
execute a external communication thread for handling communications between the real-time module and the non-real-time module.

32. The article of manufacture of claim 31 wherein the instructions further include instructions to communicate between the external communication thread, the real-time thread and the non-real-time thread using a standard communication interface.

33. The article of manufacture of claim 32 wherein the standard communication interface is an application program interface (API) call.

34. The article of manufacture of claim 31, wherein the instructions further include instructions for the external communication thread to accept commands from a communication interface and transmit the commands to the non-real-time thread, the real-time thread, or both.

35. The article of manufacture of claim 31 wherein communication between the external communication thread and the communication interface uses a standard communication protocol.

36. The article of manufacture of claim 35 wherein the communication protocol is RS-232, Ethernet, SPI, CAN BUS, RS-423, or I²C.

37. The article of manufacture of claim 31 wherein the instructions further include instructions for the non-real-time module to transmit a command directly to the real-time module.

38. The article of manufacture of claim 31 wherein the instructions further include instructions to transmit commands from the external communication thread, the real-time thread or the non-real-time thread to a controlled device.

39. A process comprising:
executing a real time thread comprising a real-time module;
executing a non-real-time thread comprising a non-real-time module independently of the real-time thread; and
executing a external communication thread for handling communications between the real-time thread and the non-real-time thread.

40. The process of claim 39, further comprising communicating between the external communication thread, the real-time thread and the non-real-time thread using a standard communication interface.

41. The process of claim 40 wherein the standard communication interface is an application program interface (API) call.

42. The process of claim 39, further comprising transmitting commands from a communication interface to the external communication thread and transmitting the commands to the non-real-time thread, the real-time thread, or both.

43. The process of claim 42 wherein communication between the external communication thread and the communication interface uses a standard communication protocol.

44. The process of claim 39, further comprising transmitting a command from the non-real-time thread directly to the real-time thread.

45. The process of claim 39, further comprising transmitting commands from the external communication thread, the real-time thread or the non-real-time thread to a controlled device.
